(19) United States
(12) Patent Application Publication
(10) Pub. No.: US 2006/0266464 A1
(43) Pub. Date: Nov. 30, 2006

(54) FILAMENT TAPE SYSTEM & METHOD THEREOF

(76) Inventor: Mark White, McDonough, GA (US)

Correspondence Address: PAPARELLA & ASSOCIATES, PLC, 930 N. WASHINGTON AVE., LANSING, MI, 48906, US

(21) Appl. No.: 11/419,931

(22) Filed: May 23, 2006

Related U.S. Application Data
(60) Provisional application No. 60/684,305, filed on May 24, 2005.

(51) Int. Cl. B32B 37/00; B44C 7/00; B32B 38/10

(52) U.S. Cl. 156/247; 156/577; 156/579

(57) ABSTRACT

An applicator for combining a tape and a filament, wherein the applicator comprises a device, the device being adapted to retain a supply of tape and a supply of filament. The applicator also includes a handle, wherein the handle is adapted to be held by a user, and a combiner, wherein the combiner is adapted to dispose a filament, from the supply of filament, onto a tape, from the supply of tape. The device is adapted to supply the tape and the filament to the combiner, and the combiner is adapted to provide a filament tape, wherein the filament tape comprises the filament disposed on the tape, and wherein further the handle is adapted to be held by a user such that the filament tape may be supplied to a desired surface for attachment thereto.

This application claims the benefit of the filing date of U.S. provisional application Ser. No. 60/684,305 entitled “Systems and Methods for Applying Edge-Trimming Tape” which was filed on May 24, 2005 and which is herein incorporated by reference.

### BACKGROUND OF THE INVENTION

The present invention relates to a tape product, and more specifically to a taping system and method therefore.

It has become increasingly common to apply curable coatings (i.e. polyurethane coatings) to an exposed vehicle surface, such as a truck bed in order to offer protection against, for example, corrosion, moisture, or abrasion. These coatings are often applied by spraying or rolling the material on to the desired surface, and allowing the coating material to dry or cure in place.

These coatings must generally be applied relatively quickly, and in applying the mixture by spraying or rolling, the surface(s) which are not intended to be coated must be covered or masked in order to protect those areas from being coated. Additionally, subsequent trimming of the coating material is a common practice in order to remove the unwanted coating material, to provide a neat appearance, and to provide access to areas that ought not have been coated, such as drains or electrical outlets.

One particularly useful application is the use of spray-on coatings (spray-on-liner) to line or protect a truck-bed (the rear-bed or box of a pick-up truck). This application is one in which the appearance of both the coated and uncoated surfaces is particularly important, and one in which a significant amount of masking may be required. Such a spray-on-liner provides protection against the corrosive elements, as well as against abrasion caused by various materials that may be carried in the bed of the truck.

These spray-on linings provide a coating, typically of polyurethane, that is tightly bonded to the truck body and which does not permit the entry of dirt or moisture between the spray-on lining and the truck body. Also, the flexible properties of the polyurethane coating offer a slip resistant, as well as protective surface for the cargo to ride on. In the case of a lining for a pick-up truck box, the lining is generally applied to the floor and side walls of the box and to some portion of the top rails and side body. As such, it is important to provide a neat edge along the perimeter of the box due to its high visibility. Therefore, the rear of the box is generally masked to avoid applying any coating to the unwanted areas. However, many of these areas, especially the high visibility areas, must be trimmed either for appearance or performance.

The surface area that is covered by the sprayed or rolled on material may be determined, or bounded by masking the surface that is not intended to be covered. In these operations, masking tape and/or other masking materials are used. These materials typically have an adhesive coating that is sufficiently strong to hold the masking material in place during application, and yet permits the easy removal of the masking material when it is no longer required.

After the application of the coating material, however, some manual trimming may still be required. This is commonly done by cutting the coating material along the boundary of the masked area (i.e., with a sharp cutting tool), to separate the coating that is to remain in place from the coating material that is to be removed. Once this separation is made, it is then possible to remove the masking tape and other masking material, as well as the unwanted coating. It is extremely important in such a trimming application that the cut be made precisely along the edge of the masking material, and at the right depth, in order to ensure the coating is adequately removed without cutting into the underlying finish, as this would allow rust to form on the improperly cut area.

One difficulty in using the relatively thick, abrasion-resistant coatings, such as polyurethane coatings, is the difficulty in locating the edges that are to be trimmed. While the removal of masking material in other applications, for example in color painting applications, effectively acts as an edge trimming method (tearing or cutting the paint layer as the masking material is removed), conventional masking materials will not tear through the thick coatings used in the aforementioned applications, such as those used to line a truck box.

Various methods have been developed to overcome this difficulty. For example, several layers of masking tape may be used, wherein the individual layers are removed sequentially so that each layer of masking tape removes individual, thin layers of the coating material. Another common method is to simply cut the coating along the edge of the masking material with a knife or other sharp instrument. Of course, as described herein above, this requires locating the edge of the masking material, and then cutting the protective coating with a sharp instrument such as a knife. Almost invariably this has the result of cutting or scoring the underlying surface, which is a particular problem with painted surfaces such pick-up truck beds, and requires that the line which has been cut or scored into the truck bed be repainted before the vehicle can be delivered to the consumer.

However, a newer method for masking these heavy coatings has been developed and includes combining masking tape with a relatively strong filament. The filament, wire, or string is carried either within the backing of the tape or within the adhesive on the tape, and is typically disposed slightly inboard of one edge of the masking tape. The tape and filament are fabricated into rolls, similar to a roll of standard masking tape. In this manner, when the tape is to be removed, the filament is used to cut the through the heavy coating during the removal of the masking tape. Unfortunately, the tape is relatively expensive, and comes in numerous variations. For example, the specific materials used, sizes, and/or properties of the materials can all be varied to provide a product suited for a particular purpose. For instance, the backing material and size, the adhesive material and quantity, and the filament material and size can all be varied to suit particular purposes. As such, the shop utilizing these materials may have to purchase and store numerous rolled products.

Accordingly, a need exists for novel systems and methods which have, among other advantages, ease of use, and lower cost, while simultaneously reducing the number of products that are required. Therefore, a taping system that solves the aforementioned disadvantages and having the aforementioned advantages is desired.

### SUMMARY OF THE PRESENT INVENTION

The aforementioned drawbacks and disadvantages of these former taping systems have been identified and a solution is set forth herein by the inventive taping system which includes an applicator for combining a tape and a filament, wherein the applicator comprises a device, the device being adapted to retain a supply of tape and a supply of filament. The applicator also includes a handle, wherein the handle is adapted to be held by a user, and a combiner, wherein the combiner is adapted to dispose a filament, from the supply of filament, onto a tape, from the supply of tape. The device is adapted to supply the tape and the filament to the combiner, and the combiner is adapted to provide a filament tape, wherein the filament tape comprises the filament disposed on the tape, and wherein further the handle is adapted to be held by a user such that the filament tape may be supplied to a desired surface for attachment thereto.

Another aspect of the present invention includes a hand applicator for combining a tape and a filament, wherein the applicator includes: a device which includes one or more axles for rotatably holding a roll of tape and a roll of filament; a handle adapted to be held by a user; and a combiner, wherein the combiner adapted to guide and dispose a continuous filament, from the roll of filament, onto a continuous tape, from the roll of tape. The device is adapted to supply the continuous tape and the continuous filament to the combiner, and the combiner is adapted to provide a filament tape, wherein the filament tape comprises the continuous filament disposed on the continuous tape, wherein further the handle is adapted to be held by a user such that the filament tape may be continuously supplied to a desired surface for releasable attachment thereto.

In another aspect of the present invention, a hand applicator for combining a tape and a filament is provided, wherein the applicator comprises: an axle for rotatably and adjacently holding a roll of tape and a roll of filament; a handle adapted to be held by a user, and adapted to retain the device; an elongated connecting arm which offsets and transversely connects the handle to the axle; and a combiner, wherein the combiner is adapted to guide and dispose a filament, from the roll of filament, longitudinally, onto a first surface of a tape, from the roll of tape, whereby the first surface of the tape includes an adhesive disposed thereon. Further, the axle is adapted to supply the tape and the filament to the combiner, and the combiner is adapted to provide a filament tape. Further, the handle is adapted to be held by a user such that the filament tape may be supplied to a desired surface for releasable attachment thereto.

And still in another aspect of the present invention, a hand applicator for combining a tape and a filament is provided, wherein the applicator comprises: a case adapted to at least partially enclose a roll of tape and a roll of the filament, the case including an axle, wherein the axle is adapted to rotatably and adjacently hold the roll of tape and the roll of filament; a handle adapted to be held by a user, the handle comprising an opening in the case, whereby the axle is coaxially disposed with the handle; and a combiner, wherein the combiner is adapted to guide and dispose a continuous filament, from the roll of filament, onto a continuous tape, from the roll of tape. The case is adapted to supply the continuous tape and the continuous filament to the combiner, and the combiner is adapted to provide a filament tape, wherein the filament tape comprises the continuous filament disposed on the continuous tape and wherein further, the handle is adapted to be held by a user such that the filament tape may be continuously supplied to a desired surface for releasable attachment thereto.

And still yet in another aspect of the present invention, a method of combining a tape and a filament is provided, wherein the method includes: providing a supply of tape, and a supply of filament; providing a hand operated device adapted to retain and combine the supply of tape and the supply of filament; installing the supply of tape and the supply of filament onto the hand operated device, wherein the hand operated device is adapted to provide a filament tape.

And in still another aspect of the present invention, a method of combining and applying a tape and a filament is provided, wherein the method includes: providing a supply of tape and a supply of filament; providing a hand operated device adapted to retain and combine the supply of tape and the supply of filament; installing the supply of tape and the supply of filament onto the hand operated device; applying the filament tape to the desired surface by operating the hand operated device, wherein during operation, the hand operated device provides a filament tape, wherein the filament tape comprises a filament, from the supply of filament, disposed on the supply of tape, such that the filament tape may be supplied to a desired surface for releasable attachment thereto.

And in yet another aspect of the present invention, a method of applying a spray on coating for vehicle beds and the like is provided, wherein the method comprises: providing a vehicle with a bed; providing a supply of tape, and a supply of filament; providing a hand operated device adapted to retain and combine the supply of tape and the supply of filament; installing the supply of tape and the supply of filament onto the hand operated device; applying the filament tape to the desired surface by operating the hand operated device, wherein during operation, the hand operated device provides a filament tape, wherein the filament tape comprises a continuous filament, from the supply of filament, disposed on the supply of tape, such that the filament tape may be continuously supplied to the desired surface for releasable attachment thereto.

Other objects, advantages, and features of the invention will become apparent upon consideration of the following detailed description, when taken in conjunction with the accompanying drawings. The above brief description sets forth rather broadly the more important features of the present disclosure so that the detailed description that follows may be better understood, and so that the present contributions to the art may be better appreciated. There are, of course, additional features of the disclosures that will be described hereinafter which will form the subject matter of the claims.

In this respect, before explaining the preferred embodiment of the disclosure in detail, it is to be understood that the disclosure is not limited in its application to the details of the construction and the arrangement set forth in the following description or illustrated in the drawings. The taping system of the present disclosure is capable of other embodiments and of being practiced and carried out in various ways. Also, it is to be understood that the phraseology and terminology employed herein are for description and not limitation. Where specific dimensional and material specifications have been included or omitted from the specification or the claims, or both, it is to be understood that the same are not to be incorporated into the claims.

As such, those skilled in the art will appreciate that the conception, upon which this disclosure is based, may readily be used as a basis for designing other structures, methods, and systems for carrying out the several purposes of the present invention. It is important, therefore, that the claims are regarded as including such equivalent constructions as far as they do not depart from the spirit and scope of the present invention.

Further, the purpose of the Abstract is to enable the U.S. Patent and Trademark Office and the public generally, and especially the scientists, engineers, and practioners in the art who are not familiar with the patent or legal terms of phraseology, to learn quickly, from a cursory inspection, the nature of the technical disclosure of the application. Accordingly, the Abstract is intended to define neither the invention nor the application, which is only measured by the claims, nor is it intended to be limiting as to the scope of the invention in any way.

These and other objects, along with the various features, and structures that characterize the invention, are pointed out with particularity in the claims annexed to and forming a part of this disclosure. For a better understanding of the taping system of the present disclosure, its advantages, and the specific objects attained by its uses, reference should be made to the accompanying drawings and descriptive matter in which there are illustrated and described the preferred embodiments of the invention.

As such, while embodiments of the taping system are herein illustrated and described, it is to be appreciated that various changes, rearrangements and modifications maybe made therein, without departing from the scope of the invention as defined by the claims.

### BRIEF DESCRIPTION OF THE DRAWINGS

FIG. 1 is a front view of the taping system of the present invention, excluding the filament and tape for clarity;

FIG. 2 is a side view of the taping system of FIG. 1;

FIG. 3 is a partial front view of the combiner of the taping system of FIG. 1;

FIG. 4 is a partial side view of the combiner of FIG. 3;

FIG. 5 is a partial front view of the combiner of FIG. 1 in operation and including a tape and filament disposed therein;

FIG. 6 is a partial side view of the combiner of FIG. 5, illustrating the filament being disposed on the tape, such that the combiner provides a filament tape;

FIG. 7 is a conceptual block diagram of the taping system of the present invention;

FIG. 8 is a flow chart illustrating an exemplary procedure for using the taping system of the present invention;

FIG. 9 is a side view of another embodiment of the taping system of the present invention;

FIG. 10 is a front view of the taping system of FIG. 9;

FIG. 111 is a sectional side view of the taping system of FIG. 10, taken along line XI-XI;

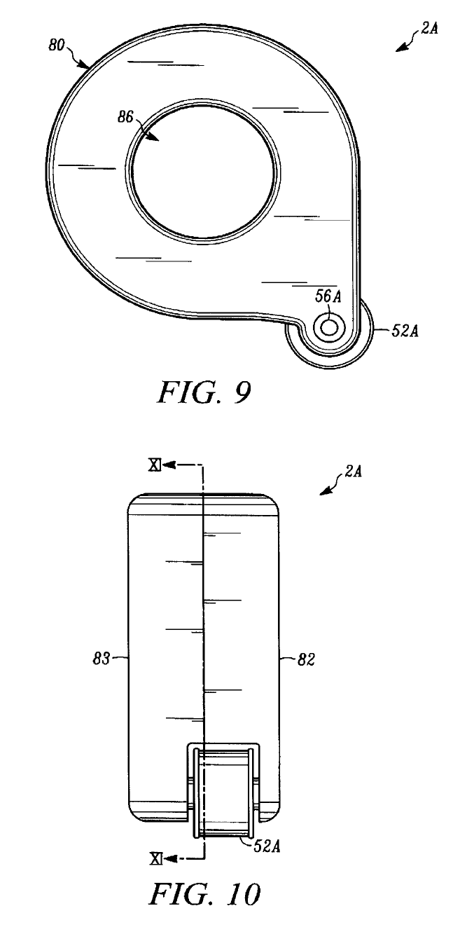

FIG. 12 is a side view of the taping system of FIG. 9, with the case in an open position showing a roll of tape and a roll of filament disposed therein;

FIG. 13 is a partial side view of the combiner of FIG. 11, illustrating the filament being disposed on the tape such that the combiner provides a filament tape;

FIG. 14 is a partial side view of the taping system of FIG. 9 is use, applying the filament tape to a desired surface;

FIG. 15 illustrates a partial side view of the filament tape disposed on the desired surface;

FIG. 16 illustrates a bottom view of the filament tape including a filament disposed along one edge of the tape; and

FIG. 17 illustrates a flow chart depicting an exemplary method of using the taping system of the present invention.

### DETAILED DESCRIPTION OF THE PREFERRED EMBODIMENT

The best mode for carrying out the invention is presented in terms of the preferred embodiment, wherein similar referenced characters designate corresponding features throughout the several figures of the drawings.

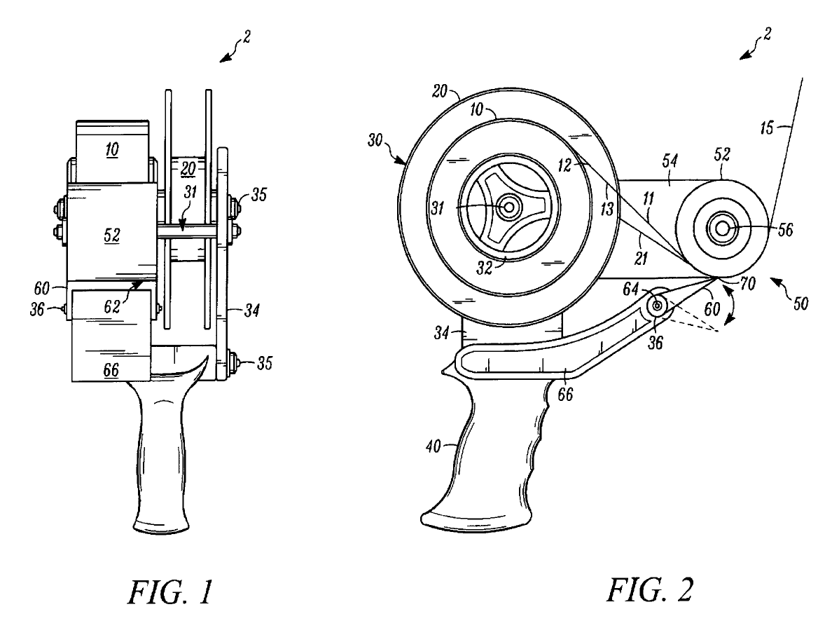

For purposes of description herein, the terms “upper”, “lower”, “right”, “left”, “rear”, “front”, “vertical”, “horizontal”, and derivatives thereof, shall relate to the invention as oriented in FIG. 1. However, it is to be understood that the invention may assume various alternative orientations, except where expressly specified to the contrary. It is also to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Reference will now be made in detail to the present preferred embodiments of the invention, examples of which are illustrated in the accompanying drawings. Wherever possible, these same referenced numerals will be used throughout the drawings to refer to the same or like parts. Like features between the various embodiments utilize similar numerical designations. Where appropriate, the various similar features have been further differentiated by an alphanumeric designation, wherein the corresponding alphabetic designator has been changed. Further, the dimensions illustrated in the drawings (if provided) are included for purposes of example only and are not intended to limit the scope of the present invention. Additionally, particular details in the drawings which are illustrated in hidden or dashed lines are to be considered as forming no part of the present invention.

As used herein, the term tape is meant to be used and defined in its general and ordinary sense. That is to say a flexible strip of cloth, metal, paper, or plastic which typically includes an adhesive disposed on one or more sides. Of course, this is not meant to be limiting in any manner and any strip of material may be used, and as described in more detail below, may include strips that do not contain an adhesive coating on one or more sides.

As used herein, the term filament is meant to be used and defined in its general and ordinary sense. That is to say a relatively thin, and therefore flexible, thread, fiber, wire, or the like. The filament described herein may be manufactured by any known process including, being spun, woven, twisted, extruded, or the like and may be manufactured by any known material(s) including, but not limited to, plastics and metals, either natural or man-made. Of course, this too is not meant to be limiting in any manner.

Spray-on linings provide a coating for a desired surface that is tightly bonded to the surface, and as such, does not permit the entry of dirt or moisture between the spray-on lining and the desired surface. Additionally, the (typically) flexible properties of the coating offer a slip resistant as well as protective surface. In the case of a lining for a pick-up truck box, the lining is generally applied to the floor and side walls of the truck bed and possibly to a portion of the top rails and even to the side body, if desired. Hence, because this surface is visible, it is important to provide a neat, crisp, and clean edge along the perimeter thereof. Therefore, the bed is generally masked to avoid applying any coating to the unwanted areas.

However, after the application of the coating material trimming is required. This is commonly done by cutting the coating material along the boundary of the masked area (i.e., with a sharp cutting tool) to separate the coating that is to remain in place, from the coating material that is to be removed. Once this separation is made, it is then possible to remove the masking tape and other masking material, as well as the unwanted coating. It is extremely important in such a trimming application that the cut be made precisely along the edge of the masking material, and at the right depth, in order to ensure the coating is adequately removed without cutting into the underlying finish, as this would allow rust to form on the improperly cut area.

Another problem with using these relatively thick, abrasion-resistant coatings is the difficulty in locating the edges that are to be trimmed. While the removal of masking material which used for color painting effectively acts as an edge trimming method (tearing or cutting the paint layer as the masking material is removed), conventional masking materials will not tear through the thick (polyurethane) coating such as those used to line a truck box. As such, various methods have been developed to overcome these difficulties. For example, in addition to cutting the coating as described above, several layers of masking tape may also be used, wherein the individual layers are removed sequentially so that each layer of masking tape removes individual, thin layers of the coating material.

However, newer methods for masking these heavy coatings have been developed and include combining masking tape with a relatively strong filament. The filament is carried either within the backing of the tape or within the adhesive on the tape, and is typically disposed slightly inboard of one edge of the masking tape. The tape and filament are fabricated into rolls, similar to a roll of standard masking tape. In this manner, when the tape is to be removed, the filament is used to cut the through the heavy coating during the removal process. However, the tape is relatively expensive, and comes in numerous variations. For example, the specific materials used, sizes, and/or properties of the tape and/or filament can all be varied to provide a product suited for a particular purpose. For instance, the backing material and size, the adhesive material and quantity, and the filament material and size can all be varied to suit a particular purpose. As such, the tradesman utilizing these materials may have to purchase and store numerous rolled products.

Accordingly, a need exists for novel systems and methods which have, among other advantages, simplicity, ease of use, lower cost, and the ability to cut the coating without using sharp instrument which can, for example, cut through a protective coating of paint. Therefore, a taping system that solves the aforementioned disadvantages and having the aforementioned advantages is desired.

The disadvantages and drawbacks of the prior art are overcome through the taping system of the present invention, wherein one preferred embodiment is disclosed in FIGS. 1-6. Referring now to FIG. 1, there is shown an applicator 2 for combining a tape 11 and a filament 21, wherein applicator 2 comprises a device 30 which is adapted to retain a supply of tape 10, and a supply of filament 20. A handle 40 is also included, wherein handle 40 adapted to be held by a user. Applicator 2 also includes a combiner 50 which is adapted to dispose a filament 21, from the supply of filament 20, onto a tape 11, from the supply of tape 10, wherein device 30 is adapted to supply tape 11 and filament 21 to combiner 50, and combiner 50 is adapted to provide a filament tape 15, wherein filament tape 15 comprises tape 11 including filament 21 disposed thereon. Further, handle 40 is adapted to be held by a user (not shown) such that filament tape 15 may be supplied to a desired surface 4 for attachment thereto (see generally FIG. 14).

Device 30 is adapted to retain, hold, and/or store a supply of tape 10 and a supply of filament 20. In one preferred embodiment, device 30 is adapted to retain the supply of tape 10 and the supply of filament 20 by utilizing a single axle 31. In one particular configuration illustrated by FIGS. 1 and 2, a roll of tape 10 and a roll of filament 20 are adjacently and rotatably mounted on axle 31 via core 32 as is known in the art and similar, in appearance only, to package taping applicators which are known in the art. Of course this is merely an example and numerous other configurations may be utilized. For example filament supply 20 need not be supplied on a roll. Instead, device 30 may utilize a supply of filament 20 in numerous other forms. For that matter, supply of tape 10 may also be provided in numerous other forms other than rolled goods. As such, no axle 31 may be required. Further yet, multiple axles 31 may be used to thereby mount rolled tape 10 and rolled filament 20 independently.

As such, the specific configurations and features of device 30 may vary according to specific requirements, and as generally known in the art. In the preferred embodiment, device 30 includes a single axle 31 for adjacently and rotatably mounting a roll of tape 10 and a roll of filament 20. However, as described previously, this is merely illustrative of a preferred embodiment and supply of tape 10 and supply of filament 20 are to be defined not with regards to any specific configuration, such as rolled or coiled goods, unless so defined by the claims. Therefore, device 30 may be configured to retain or supply numerous configurations of tape and filament which are known in the art. For example, one such configurement may utilize a roll of tape 10 on an axle 31, however, the supply of filament 20 may be simply a box of filament, or a coil of filament.

When the term tape is used herein, it is meant to be used and defined in its general and ordinary sense. That is to say a flexible strip of cloth, metal, paper, or plastic, which typically includes an adhesive disposed on one or more sides. Of course, this is not meant to be limiting in any manner and any strip of material may be used, and as described in more detail below, may include strips that do not contain an adhesive coating on one or more sides. However, in one preferred embodiment a paper masking tape is used, as is commonly known in the art. Additionally, when the term filament is used herein, it is meant to be used and defined in its general and ordinary sense. That is to say a relatively thin, and therefore flexible, thread, fiber, wire, or the like. The filament described herein may be manufactured by any known process including, being spun, woven, twisted, extruded, or the like and may be manufactured from any known material(s) including, but not limited to, plastics and metals, either natural or man-made. Of course, this too is not meant to be limiting in any manner. In one preferred embodiment a relatively thin and flexible metal wire is used, and in another example a plastic line, similar to a fishing line is used. The diameter of the filament may be, for example, from about 0.006 inches to about 0.016 inches.

Applicator 2 also includes a handle 40. Handle 40 is adapted to be held by a user, such that applicator 2 may be held, retained, and to some degree, controlled by handle 40. In the embodiment illustrated in FIG. 1, handle 40 is an elongated pistol grip style handle and device 30 includes an elongated connecting arm 34 which attaches, offsets and transversely couples or otherwise connects handle 40 to axle 31. In this configuration the roll of tape 10 and the roll of filament 20 may be rotatably and adjacently disposed on axle 31 such that handle 40 may used to control the dispensing of tape 10 and filament 20 as described in more detail below. Of course, and any style or form of handle 40 may be used.

The specific configurations and features of first handle 40 may vary according to specific requirements. In one preferred embodiment, handle 40 is generally a pistol style grip handle and is connected to device 30 via bolts 35, which in one preferred configuration are used to attach connecting arm 34 to handle 40 and axle 31. However, the particular connection method may vary according to specific requirements. Further, although one preferred embodiment of handle 40 and device 30, including connecting arm 34, are fabricated into a multi-piece configuration, a one-piece configuration may be utilized. Further, although this particular embodiment is assembled by bolts, various other ways, such as fasteners, welding, and other techniques known in the art may also be used.

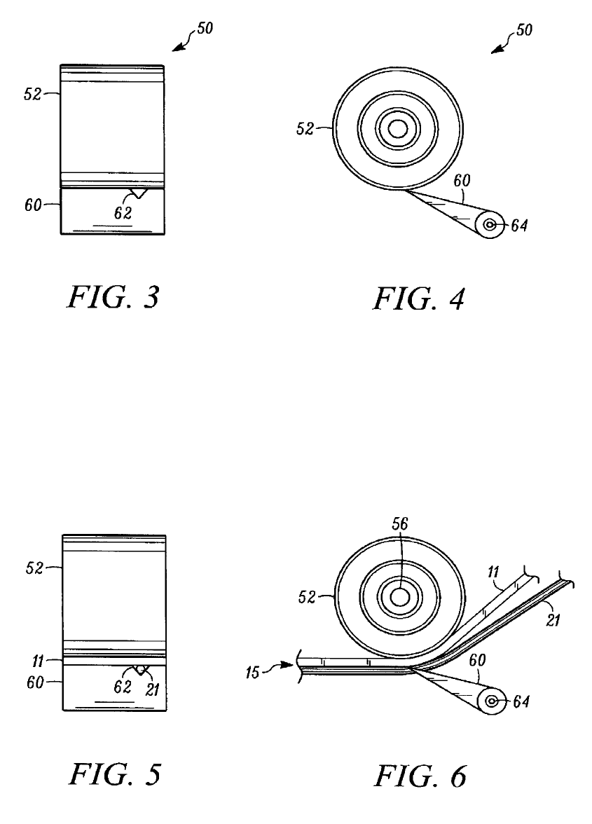

Applicator 2 also includes a combiner 50 (FIGS. 3-6) which is adapted to dispose a filament 21, from the supply of filament 20, onto a tape 11, from the supply of tape 10, wherein device 30 is adapted to supply tape 11 and filament 21 to combiner 50, as described above, and combiner 50 is adapted to provide filament tape 15, wherein filament tape 15 comprises tape 11 having filament 21 disposed thereon. Combiner 50 provides or creates filament tape 15 by, in one preferred embodiment, guiding filament 21 onto an adhesive 12 which is disposed on a first side 13 of tape 11. Guiding is accomplished, for example, by a notch 62 disposed in blade 60 (FIG. 5). After guiding filament 21 onto tape 11, a roller 52, in conjunction with blade 60, combines or merges filament 21 into or onto adhesive 12 (FIG. 6). This may be accomplished, for example, by biasing either roller 52 towards blade 60, or vice versa. In one exemplary embodiment, roller 52 is attached or otherwise disposed to device 30 via link 54 which includes axle 56, such that roller 52 is rotatably mounted thereto. Additionally, in this embodiment blade 60 is rotatably attached to connecting arm 66 via axle 64 which is attached or otherwise a part of handle 40. Additionally, a cutter 70 may be attached or otherwise operably connected to applicator 2. For example, in one embodiment a cutting tip 70 is included on blade 60 such that with the proper amount of force applied thereto, filament tape 15 is cut. Of course, other cutting methods may be used including scissor style cutting mechanisms.

The specific configurations and features of combiner 50, blade 60, link 54 and connecting arm 66 may vary according to specific requirements. Although the preferred embodiment has heretofore been described, numerous other configurations and attachment methods may be used. Further, although one preferred embodiment is fabricated into a multi-piece configuration and assembled by various means such as fasteners, welding, and the like, a one-piece configuration may be utilized. Still further yet, although the preferred embodiment utilizes a compressible roller 52 and a generally rigid blade 60 to aid in the application of filament tape 15, these are merely examples of material characteristics and numerous other materials and characteristics may be utilized as the specific requirements dictate.

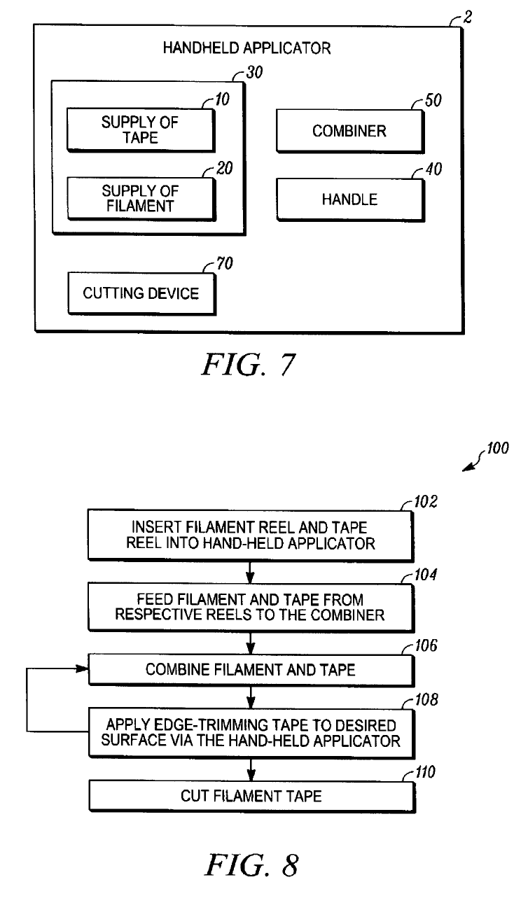

Having described a first embodiment, it is to be observed that the specific configurations and features of applicator 2 may vary according to the specific requirements of the user. As such, FIG. 7 generally illustrates the overall concept of the present invention, which includes a hand applicator 2 comprising a device 30 including, supply tape 10 and a supply of filament 20 operably disposed within device 30, whereby applicator 2 is held by a user via handle 40, whereby further the user may cut the combined filament tape through a cutter 70.

In use then (FIG. 8), a method 100 of using applicator 2 includes making applicator 2 ready for use by inserting or otherwise installing tape supply 10 and filament supply 20 into or onto device 30 (102). Tape supply 10 and filament supply 20 are then fed or otherwise operably connected to combiner 50 (104), whereby tape supply 10 and filament supply 20 are combined to create filament tape 15 (106). For installation to the desired surface 4, the user may utilize roller 52 to apply filament tape 15 to desired surface 4 (108) (see generally FIG. 14). In this preferred embodiment, steps 106 and 108 occur substantially simultaneously as the user applies the filament tape. This is accomplished because as the user rolls filament tape 15 on desired surface 4 via roller 52, combiner 50 is being supplied with and combining tape 11 an filament 21. Finally, when the user is finished applying filament tape 15, the user may use cutter 70 to cut filament tape 15, thereby stopping the tape application (110).

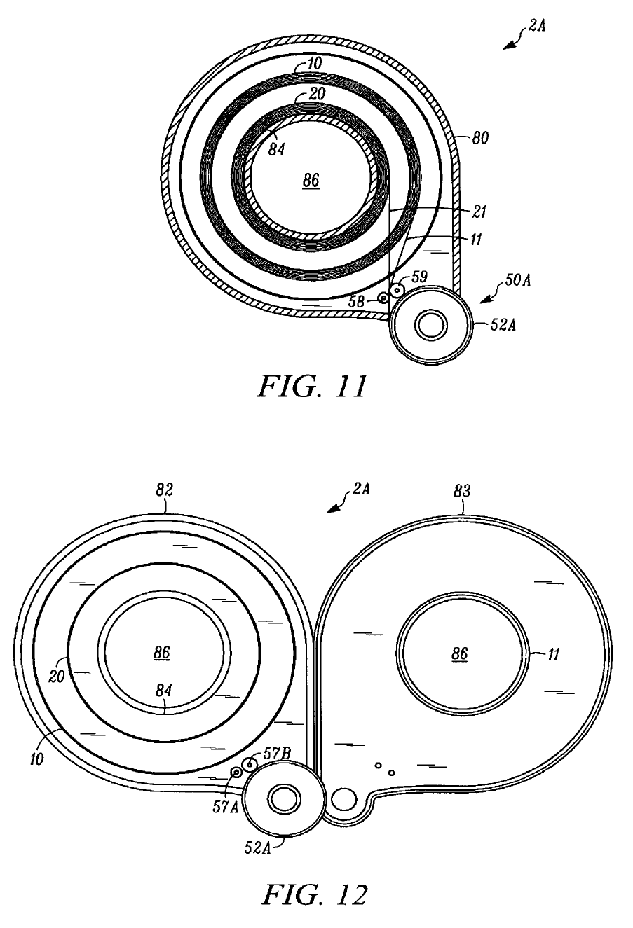

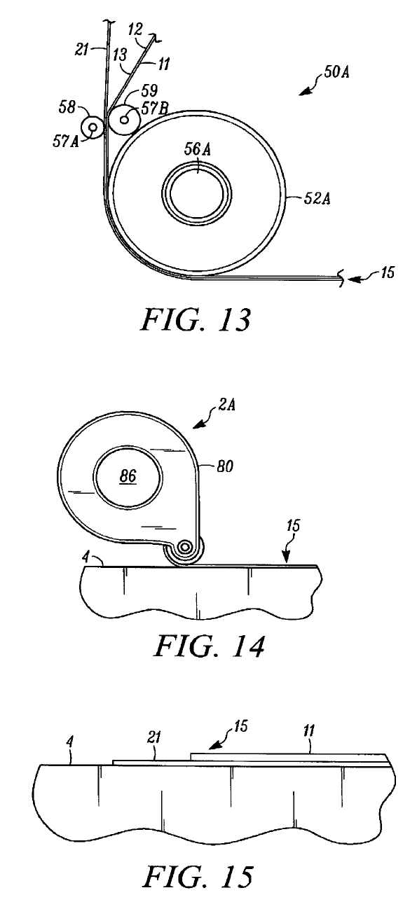

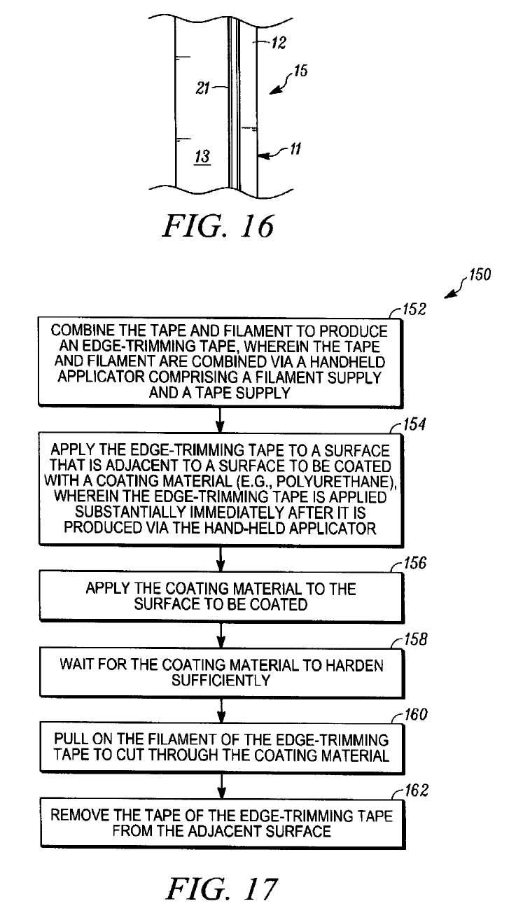

FIGS. 9-14 illustrate another embodiment 2A of the applicator. Embodiment 2A is similar to embodiment 2 in that tape supply 10 and filament supply 20 are fed or otherwise operably connected to combiner 50A (FIG. 11), whereby tape supply 10 and filament supply 20 are unrolled to produce a tape 11 and a filament 12 which are combined or otherwise brought together to create filament tape 15 (FIG. 13). As illustrated by FIG. 9, this embodiment includes a case or housing 80 which, in this embodiment, fully encloses tape supply 10 and filament supply 20. In one embodiment case 80 comprises an openable case having hingedly connected first and second halves 82 and 83, respectively (FIG. 12). Disposed or otherwise removed from case 80 is opening 86. In this embodiment, opening 86 is coaxially disposed with axle 84 such that tape supply 10 and filament supply 20 are rotatably and adjacently mounted to axle 84. In this manner, opening 86 can be used as a handle to, at least partially, control applicator 2A via case 80, thereby applying filament tape 15.

As illustrated by FIG. 11, combiner 50A includes a roller 52A, a filament roller 58 and a tape roller 59. Rollers 58 and 59 replace blade 60 of the first embodiment. However, their action is similar in that roller 58 and 59 are biased, towards one another, as is known in the art, and combine tape 11 and filament 21 as described previously. Further, rollers 58 and 59 may also guide tape 11 and filament 21 in various manners known in the art. As described above with respect to the first embodiment, rollers 52A, 58, and 59 may all be rotatingly disposed within case or housing 80 via axles 56A, and 57A or B, respectively, or by any other manner known in the art.

In use then (FIG. 14), applicator 2A is made ready for use by inserting or otherwise installing tape supply 10 and filament supply 20 onto axle 84. Tape supply 10 and filament supply 20 are then fed or otherwise operably connected to combiner 50A, whereby tape 11 and filament 21 are guided and combined by rollers 58 and 59, to create filament tape 15. For installation to the desired surface 4, the user may utilize roller 52A to apply filament tape 15 to desired surface 4, and in this preferred embodiment the combining of tape 11 and filament 21, and the applying of tape 15 occur substantially simultaneously as the user applies filament tape 15. This is accomplished because as the user rolls filament tape 15 on desired surface 4, via roller 52A, filament roller 58 and tape roller 59 are also made to roll. This is because, in this example, roller 59 is in contact with roller 52A, as well as being biased against roller 58. Therefore when roller 52A is rolled to apply tape 15, rollers 58 and 59 are also rolled to thereby continuously supply the user with tape 15. Again, as in the first embodiment, when the user is finished applying filament tape 15, the user may cut filament tape 15, thereby stopping the tape application. Although a cutter is not illustrated, a cutter may be provided to this embodiment, as is generally known in the art.

FIG. 16 illustrates filament tape 15 and shows the first side 13 of tape 111 including adhesive 12 disposed thereon. In this configuration, filament 21 is shown continuously, and at least partially, embedded within adhesive 12 along an edge on tape 11, after it is combined with combiner 50 or 50A. Of course, this too is not meant to be limiting, and it is envisioned that filament 21 may be applied anywhere along one or even both surfaces of tape 11 and further, that either the tape need not have an adhesive, or in addition to the adhesive on tape 11, filament 21 may have its own adhesive disposed thereon.

In yet another embodiment, a method of combining a tape 11 and a filament 21 includes the steps of: 1) providing a supply of tape 10 and a supply of filament 20; 2) providing a hand operated device 2 adapted to retain and combine the supply of tape 10 and the supply of filament 20, whereby in one embodiment, the hand operated device 2 includes a handle 40, and a combiner 50 adapted to guide a continuous filament 21 from the supply of filament 20 onto an adhesive 12 disposed on a continuous tape 11 from the supply of tape 10, and adapted to dispose the continuous filament 21 on the continuous tape 11, in order to provide a filament tape 15 wherein the continuous filament tape 15 comprises a continuous filament 21 disposed thereon; 3) installing the supply of tape 10 and the supply of filament 20 onto the hand operated device 2, wherein the hand operated device 2 is adapted to provide a filament tape 15, such that the filament tape 15 may be continuously supplied to a desired surface 4 for releasable attachment thereto.

In still another embodiment a method of combining and applying a tape and a filament includes the steps of: 1) providing a supply of tape 10, the tape 10 including an adhesive 12 applied to at least one side 13 thereof, and a supply of filament 20; 2) providing a hand operated device 2 adapted to retain and combine the supply of tape 10 and the supply of filament 20, the hand operated device 2 including a handle 40, and a combiner 50 adapted to guide a continuous filament 21 from the supply of filament 20 onto the adhesive 12 disposed on a continuous tape 11 from the supply of tape 10, and adapted to dispose the continuous filament 21 on the continuous tape 11, in order to provide a filament tape 15 wherein the continuous filament tape 15 comprises a continuous filament 21 disposed thereon; 3) installing the supply of tape 10 and the supply of filament 20 onto the hand operated device 2; and then 4) applying the filament tape 15 to a desired surface 4 by operating the hand operated device 2, wherein during operation, the hand operated device 2 provides a filament tape 15, wherein the filament tape 15 comprises a continuous filament 21, from the supply of filament 20, disposed on the tape 11, such that the filament tape 15 may be continuously supplied to the desired surface 4 for releasable attachment thereto.

As illustrated by FIG. 17, in still yet another embodiment, a method 150 of applying a spray on coating for truck beds and the like includes the steps of: 1) providing a vehicle with a bed; 2) providing a supply of tape 10, and a supply of filament 20; 3) providing a hand operated device 2 adapted to retain and combine the supply of tape 10 and the supply of filament 20; 4) installing the supply of tape 10 and the supply of filament 20 onto the hand operated device 2; 5) applying the filament tape 15 to the desired surface 4 adjacent the bed (154) by operating the hand operated device 2, wherein during operation, the hand operated device 2 provides a filament tape 15 (152), wherein the filament tape 15 comprises a continuous filament 21, from the supply of filament 20, disposed on the tape 11, such that the filament tape 15 may be continuously supplied to the desired surface 4 for releasable attachment thereto; 6) applying a coating to the desired surface 4 (156); 7) allowing the coating to dry to a sufficient degree, for example to a degree such that it is not tacky to the touch, or for example, such that it is substantially cured (158); 8) removing the filament 21 by grasping filament 21 and pulling filament 21 through the applied coating, thereby cutting through the applied coating (160); and 9) removing the remaining tape from the adjacent surface (162).

Advantageously, the taping system of the present invention has, among other advantages, simplicity, ease of use, lower cost, and the ability to cut through a coating without using sharp instruments which can, for example, cut through a protective coating of paint. Additionally, the taping system of the present invention is easier to use than existing taping systems.

The solutions offered by the invention disclosed herein have thus been attained in an economical, practical, and facile manner. To whit, a novel taping system which is cost effective, easily installed, and safer has been invented. While preferred embodiments and example configurations of the inventions have been herein illustrated, shown, and described, it is to be appreciated that various changes, rearrangements, and modifications may be made therein, without departing from the scope of the invention as defined by the claims. It is intended that the specific embodiments and configurations disclosed herein are illustrative of the preferred and best modes for practicing the invention, and should not be interpreted as limitations on the scope of the invention as defined by the claims, and it is to appreciated that various changes, rearrangements, and modifications may be made therein, without departing from the scope of the invention as defined by the claims.

The invention claimed is:

1. An applicator for combining a tape and a filament, the applicator comprising:
a device, the device adapted to retain a supply of tape and a supply of filament;
a handle, the handle adapted to be held by a user; and
a combiner, the combiner adapted to dispose a filament, from the supply of filament, onto a tape, from the supply of tape;
wherein the device is adapted to supply the tape and the filament to the combiner, and the combiner is adapted to provide a filament tape, the filament tape comprising the filament disposed on the tape, wherein further the handle is adapted to be held by a user such that the filament tape may be supplied to a desired surface for attachment thereto.

2. The applicator according to claim 1, wherein:
the handle comprises an opening in the device.

3. The applicator according to claim 1, wherein:
the handle is coupled to the device.

4. The applicator according to claim 1, wherein:
the device includes a single axle, the single axle adapted to rotatably hold a roll of tape.

5. The applicator according to claim 1, wherein:
the device includes a single axle, the single axle adapted to rotatably and adjacently hold a roll of tape and a roll of filament.

6. The applicator according to claim 5, wherein:
the device includes an elongated connecting arm which offsets and couples the handle to the axle;
wherein the combiner is adapted to guide and dispose the filament longitudinally onto a first surface of the tape, the first surface of the tape including an adhesive disposed thereon.

7. The applicator according to claim 5, wherein:
the device includes a housing, the housing adapted to at least partially enclose the roll of tape and the roll of filament.

8. The applicator according to claim 7, wherein:
the handle comprises an opening in the housing.

9. The applicator according to claim 8, wherein:
the axle is coaxially disposed with the handle.

10. A hand applicator for combining a tape and a filament, the applicator comprising:
a device including one or more axles for rotatably holding a roll of tape and a roll of filament;
a handle adapted to be held by a user; and
a combiner, the combiner adapted to guide and dispose a continuous filament, from the roll of filament, onto a continuous tape, from the roll of tape;
wherein the device is adapted to supply the continuous tape and the continuous filament to the combiner, and the combiner is adapted to provide a filament tape, the filament tape comprising the continuous filament disposed on the continuous tape;
wherein further the handle is adapted to be held by a user such that the filament tape may be continuously supplied to a desired surface for releasable attachment thereto.

11. The applicator according to claim 10, wherein:
the one or more axles includes a single axle for rotatably and adjacently holding the roll of tape.

12. The applicator according to claim 10, wherein:
the one or more axles include a single axle for rotatably and adjacently holding the roll of tape and the roll of filament.

13. The applicator according to claim 12, further including:
the device includes an elongated connecting arm which offsets and couples the handle to the axle;
wherein the combiner is adapted to guide and dispose the filament longitudinally onto a first surface of the tape, the first surface of the tape including an adhesive disposed thereon.

14. The applicator according to claim 10, further including:
the device includes a case, the case adapted to at least partially enclose the roll of tape and the roll of the filament.

15. The applicator according to claim 14, wherein:
the handle comprises an opening in the case.

16. The applicator according to claim 15, wherein:
the axle is coaxially disposed with the handle, wherein the roll of tape and the roll of filament are rotatably and adjacently disposed on the axle.

17. A hand applicator for combining a tape and a filament, the applicator comprising:
an axle for rotatably and adjacently holding a roll of tape and a roll of filament;
a handle adapted to be held by a user, and adapted to retain the device;
an elongated connecting arm which offsets and transversely connects the handle to the axle; and
a combiner, the combiner adapted to guide and dispose a filament, from the roll of filament, longitudinally, onto a first surface of a tape, from the roll of tape, the first surface of the tape including an adhesive disposed thereon;
wherein the axle is adapted to supply the tape and the filament to the combiner, and the combiner is adapted to provide a filament tape;
wherein further the handle is adapted to be held by a user such that the filament tape may be supplied to a desired surface for releasable attachment thereto.

18. A hand applicator for combining a tape and a filament, the applicator comprising:
a case adapted to at least partially enclose a roll of tape and a roll of the filament, the case including an axle, the axle adapted to rotatably and adjacently hold the roll of tape and the roll of filament;
a handle adapted to be held by a user, the handle comprising an opening in the case, whereby the axle is coaxially disposed with the handle; and
a combiner, the combiner adapted to guide and dispose a continuous filament, from the roll of filament, onto a continuous tape, from the roll of tape;
wherein the case is adapted to supply the continuous tape and the continuous filament to the combiner, and the combiner is adapted to provide a filament tape, the filament tape comprising the continuous filament disposed on the continuous tape;
wherein further the handle is adapted to be held by a user such that the filament tape may be continuously supplied to a desired surface for releasable attachment thereto.

19. A method of combining a tape and a filament, the method comprising:
providing a supply of tape and a supply of filament;
providing a hand operated device adapted to retain and combine the supply of tape and the supply of filament; and
installing the supply of tape and the supply of filament onto the hand operated device;
wherein the hand operated device is adapted to provide a filament tape.

20. The method according to claim 19, wherein:
the providing step further includes providing the supply of tape with an adhesive applied to at least one side thereof; and
the second providing step further includes providing the hand operated device with a handle and a combiner, the combiner adapted to guide a continuous filament from the supply of filament onto the adhesive disposed on the supply tape, and adapted to dispose the continuous filament on the tape, thereby providing a filament tape, wherein the filament tape comprises the supply of tape which includes the continuous filament disposed thereon;
guiding the continuous filament from the supply of filament onto the adhesive disposed on the supply of tape; and
disposing the continuous filament on the adhesive disposed on the supply tape, thereby producing the filament tape.

21. A method of combining and applying a tape and a filament, the method comprising:
providing a supply of tape and a supply of filament;
providing a hand operated device adapted to retain and combine the supply of tape and the supply of filament;
installing the supply of tape and the supply of filament onto the hand operated device;
applying the filament tape to a desired surface by operating the hand operated device, wherein during operation, the hand operated device provides a filament tape, wherein the filament tape comprises a filament, from the supply of filament, disposed on the supply of tape, such that the filament tape may be supplied to the desired surface for releasable attachment thereto.

22. The method according to claim 21, further including:
applying a coating to a second desired surface to be coated, the coating at least partially disposed on the filament tape;
allowing the coating to harden;
pulling the continuous filament disposed within the filament tape, the filament tape disposed on the desired surface, such that the hardened coating at least partially covering the filament tape is cut therethrough.
